(19) United States
(12) Patent Application Publication
(10) Pub. No.: US 2008/0241620 A1
(43) Pub. Date: Oct. 2, 2008

(54) SEPARATOR FOR COOLING MCFC, MCFC INCLUDING THE SAME AND METHOD FOR COOLING MCFC USING THE SEPARATOR

(75) Inventors: Hyung Chul Ham, Chuncheon-si (KR); Seong-Ahn Hong, Seoul (KR); In-Hwan Oh, Seoul (KR); Tae-Hoon Lim, Seoul (KR); Suk Woo Nam, Seoul (KR); Heung Yong Ha, Nowon-gu (KR); Jonghee Han, Seoul (KR); Sung Pil Yoon, Seongnam-si (KR); Jaeyoung Lee, Bupyeong-gu (KR); Hyoung-Juhn Kim, Suwon-si (KR); Eun Ae Cho, Seoul (KR); Yeong Cheon Kim, Seoul (KR); Sang-Yeop Lee, Seoul (KR)

Correspondence Address: MERCHANT & GOULD PC, P.O. BOX 2903, MINNEAPOLIS, MN, 55402-0903, US

(73) Assignee: Korea Institue of Science and Technology, Seoul (KR)

(21) Appl. No.: 11/967,521

(22) Filed: Dec. 31, 2007

(30) Foreign Application Priority Data
Mar. 23, 2007 (KR) 10-2007-0028709

(51) Int. Cl. H01M 2/14; H01M 8/02; H01M 8/04

(52) U.S. Cl. 429/26; 429/34; 429/13; 429/247

(57) ABSTRACT

A separator for cooling an MCFC has a cooling gas flow path provided in the separator, a cooling anode gas or a cooling cathode gas flowing through the cooling gas flow path, the cooling anode gas or the cooling cathode gas having a temperature lower than that of a general anode gas or a general cathode gas which is supplied to an anode or a cathode of the MCFC.

### BACKGROUND OF THE INVENTION

1. Field of the Invention

The present invention relates to a separator for cooling a molten carbonate fuel cell (MCFC), an MCFC including the same and a method for cooling an MCFC using the separator.

2. Description of the Related Art

An MCFC is generally made to have stacks including a plurality of unit cells and separators. Herein, each of the unit cells is composed of an anode, a matrix, and a cathode.

FIG. 1 shows a schematic view of the general MCFC with its gas distribution.

As shown in FIG. 1, the MCFC comprises a stack, in which a plurality of unit cells are stacked, and a separator S provided between the respective unit cells, each of the unit cells being composed of an anode A, a matrix M, and a cathode C. At the separator S, anode gas g1 or cathode gas g2 flows and is distributed to the anode A or cathode C.

In the MCFC, heat will be inevitably generated and can make the matrix, the anode, the cathode, the separator and so on deteriorated. Since such a heat generation will be larger according to the stack size, heat control in the MCFC stack can be one of important factors for the commercialization of the MCFC.

The following methods can be used for the heat control of the MCFC.

First, internal reforming of methane with steam can be used for the heat control of the MCFC. Since the internal reforming reaction is endothermic, generated heat can be removed using the endothermic reaction.

However, according to the research of the inventors, it is difficult to control the endothermic reaction in the internal reforming method, and to this end a cold spot and a thermal stress can take place. Further, since the methane conversion rate is not so high, fuel efficiency of the stack can be reduced. As well, manufacturing cost increases because an expensive direct internal reforming system is needed,

Second, operation of the stack in a low-load state can be used for the heat control of the MCFC. However, according to the research of the inventors, the efficiency of the method is not good.

Third, increasing of the heat removal speed through a pressurizing operation can be used for the heat control of the MCFC. However, according to the research of the inventors, there are difficulties in carrying out BOP operation in the method since pressure difference needs to be controlled in a pressurized state.

### SUMMARY OF THE INVENTION

There is provided a separator for cooling an MCFC comprising a cooling gas flow path provided in the separator, a cooling anode gas or a cooling cathode gas flowing through the cooling gas flow path, the cooling anode gas or the cooling cathode gas having a temperature lower than that of a general anode gas or a general cathode gas which is supplied to an anode or a cathode of the MCFC.

There is provided an MCFC comprising the separator, one or more of which is provided in a stack of the MCFC.

There is provided a method for cooling an MCFC comprising: supplying cooling anode gas or cooling cathode gas to a stack of the MCFC having one or more of the separator, thereby cooling the MCFC.

### BRIEF DESCRIPTION OF THE DRAWINGS

FIG. 1 shows a schematic view of a general MCFC with its gas distribution.

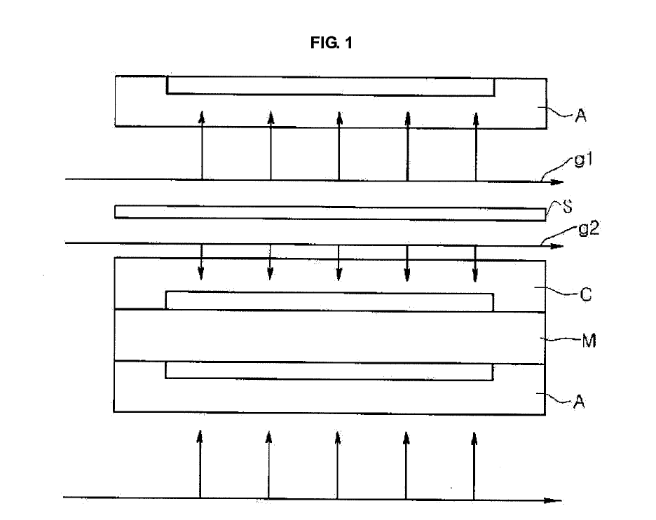

FIG. 2 shows a schematic view of an MCFC with its gas distribution, which is carried out through a separator for cooling the MCFC according to an embodiment of the present invention.

FIG. 3 shows a schematic view of the separator for cooling an MCFC according to an embodiment of the invention.

FIG. 4 shows a schematic cross-sectional view taken along line A-A′ of FIG. 3.

FIG. 5 shows a schematic view of an MCFC according to an embodiment of the invention.

FIG. 6 is a graph showing temperature changes of a cooling separator in accordance with time, in a first example of the invention.

FIG. 7 is a graph showing temperature changes of cooling separators, which are separated from each other in direction of height, in accordance with time, in a first example of the invention.

FIG. 8 is a graph showing temperature changes of a cooling separator in accordance with time, in a second example of the invention.

FIG. 9 is a graph showing temperature changes of cooling separators, which are separated from each other in direction of height, in accordance with time, in a second example of the invention.

FIG. 10 is a graph showing temperature changes of a separator in a comparative example of the invention.

### DETAILED DESCRIPTION OF THE INVENTION

Hereinafter, embodiments of the present invention will be described with reference to the accompanying drawings.

In the context, MCFC is referred to include a device for supplying anode gas or cathode gas to a stack of the MCFC.

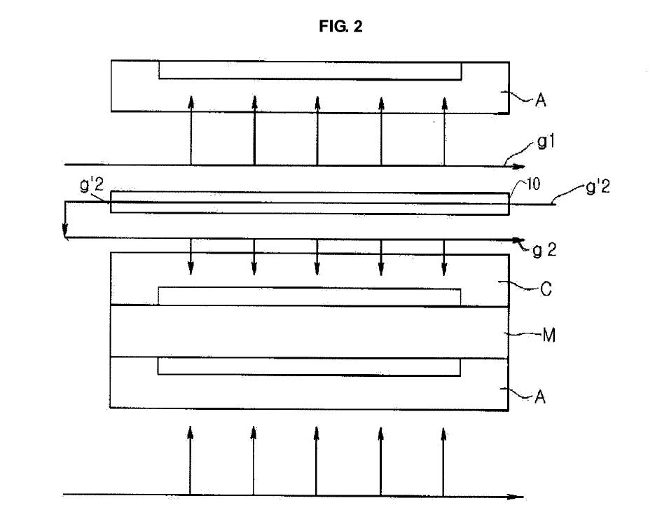

FIG. 2 shows a schematic view of an MCFC with its gas distribution, which is carried out through a separator for cooling the MCFC according to an embodiment of the present invention.

As shown in FIG. 2, a separator 10 for cooling an MCFC having a cooling gas flow path provided therein is interposed between unit cells, each of which is composed of a anode A, a matrix M, and an cathode C.

A temperature of cooling cathode gas g′2 flowing in the separator 10 is lower than that of general cathode gas g2. Further, while flowing in an opposite direction to the flow of general gases g1 and g2 in the separator 10, the cooling cathode gas g′2 is heat-exchanged with the general gases g1 and g2. The heat-exchanged cooling cathode gas g′2 is mixed with the general cathode gas g2 in the separator 10, and is then distributed into each cathode so as to be used as an oxidizing agent for electrochemical reaction.

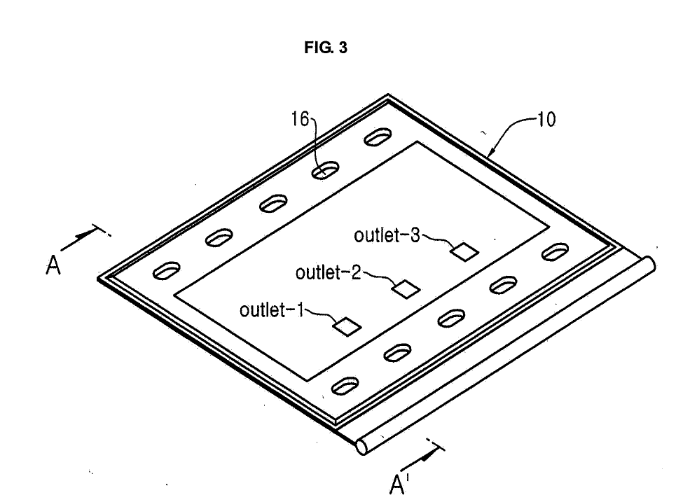

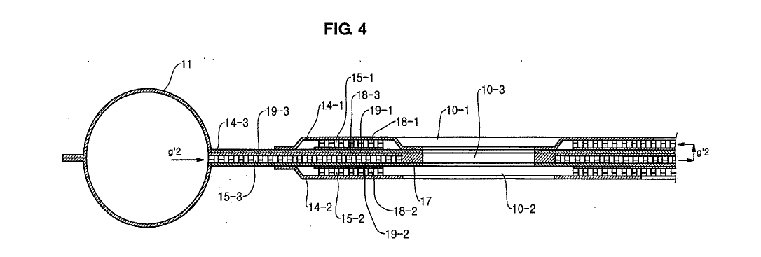

FIG. 3 shows a schematic view of a separator for cooling an MCFC according to an embodiment of the invention. FIG. 4 shows a schematic cross-sectional view taken along line A-A′ of FIG. 3.

As shown in FIGS. 3 and 4, a separator 10 has a cooling-gas inlet pipe 11 provided at one side thereof. The cooling-gas inlet pipe 11, which has for example a cylindrical shape, introduces cooling gas and guides the introduced cooling gas into inner parts of the separator 10. The separator 10 has a plurality of manifold holes 16 formed thereon, and is an internal manifold type. After being introduced into the inlet pipe 11, the cooling gas enters into the inner parts of the separator 10. Thanks to the inlet pipe 11, the distribution of cooling gas inside the separator 10 can be performed smoothly.

Referring to FIG. 4, the separator 10 for cooling an MCFC has a cooling gas flow path 10-3 interposed between a general cathode gas flow path 10-1 and a general anode gas flow path 10-2. If the separator 10 is a separator for cooling a cathode, it is good enough to provide only the general cathode gas flow path and the cooling gas flow path. And, if the separator 10 is a separator for cooling an anode, it is good enough to provide only the general anode gas flow path and the cooling gas flow path. However, when all of the general cathode gas flow path, the general anode gas flow path and the cooling gas flow path are provided, as shown in FIG. 4, both of the cathode and the anode can be cooled, and as a result, it is easy to apply the separator 10 to a stack. Accordingly, it is preferable to manufacture the separator 10 so that all the flow paths are provided therein.

The general cathode gas flow path 10-1 is covered by a cathode mask plate 14-1. With the mask plate 14-1, the general cathode gas can be sealed and the installation of an electrode can be performed. The mask plate 14-1 has a plurality of shielded slots 18-1 provided therein so as to partition off a general cathode gas channel 15-1 and to collect currents. On the mask plate 14-1, a coating layer 19-1 for preventing corrosion is formed.

The general anode gas flow path 10-2 is also covered by a general anode mask plate 14-2. With the mask plate 14-2, the general anode gas can be sealed and the installation of an electrode can be performed. The mask plate 14-2 has a plurality of shielded slots 18-2 provided therein so as to partition off a general anode gas channel 15-2 and to collect currents. On the mask plate 14-2, a coating layer 19-2 for preventing corrosion is formed.

The cooling gas flow path 10-3 is covered by a mask plate 14-3. The mask plate 14-3 separates the general cathode gas flow path 10-1 and the general anode gas flow path 10-2 from the cooling gas flow path 10-3 and seals the cooling gas.

The mask plate 14-3 has a plurality of shielded slots 18-3 provided therein so as to partition off a cooling gas channel 15-3. On the mask plate 14-3, a coating layer 19-3 for preventing corrosion is formed.

FIG. 4 shows that the coating layer 19-3 is formed on the mask plate 14-3 at the side of the general cathode gas flow path 10-1, which is in case that the separator is used for cooling the cathode. Meanwhile, in case that the separator is used for cooling the anode, the coating layer 19-3 will be formed on the mask plate 14-3 at the side of the general anode gas flow path 10-2.

The manifold holes 16 formed in the cooling gas flow path 10-3 are sealed by welding to form sealed portions 17 so that cooling gas is not introduced into the manifold holes 16.

The flow of cooling gas will be explained with reference to FIGS. 4 and 2. The cooling cathode gas g′2 introduced through the inlet pipe 11 flows through the cooling gas flow path and is introduced into the general cathode gas flow path at the end of the separator 10. Then, the cooling cathode gas g′2 is mixed with general cathode gas and then flows out of the separator 10 and is distributed into each cathode.

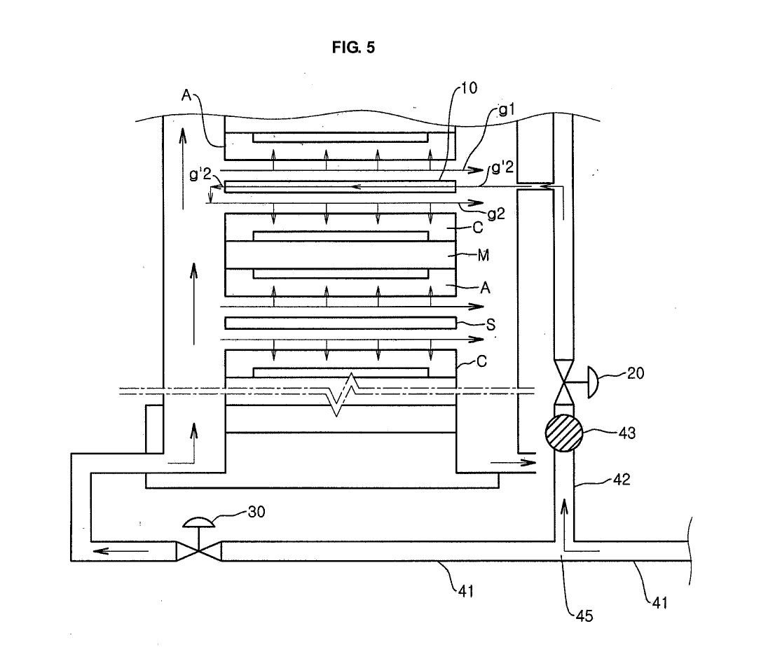

FIG. 5 shows a schematic view of an MCFC according to an embodiment of the invention.

As shown in FIG. 5, an MCFC stack has one or more separators 10 provided therein and is connected to a general gas supply flow path 41 and a cooling gas supply flow path 42. The general gas supply flow path 41 diverges into the cooling gas supply flow path 42 at a diverging point 45. The diverged general gas flow is cooled to a temperature of 500 to 600° C. by a temperature controller (for example, an electric heater) 43 installed in the middle of the cooling gas supply flow path, thereby forming cooling gas.

The gas flow in the general gas supply flow path 41 and the cooling gas supply path 42 is controlled by respective valves 30 and 20.

Specifically, general gas is supplied (S1) to perform an operation. When the temperature of the stack increases while the operation is performed, the valve 30 directed to a channel for supplying the general gas g1 is slowly closed for cooling the separator, and the valve 20 is opened to supply gas to each cooling separator of the stack. Then, the flow of the cooling gas g′2 in an opposite direction to the flow of the general gas g1 and g2 is formed (S2). Herein, the cooling gas can be supplied continuously without interrupting the supply of the general gas (S2′).

While the cooled gas g′2 is heat-exchanged with the general gases g1 and g2, the temperature of the entire stack is decreased. Gas flow through the cooling separator 10 is the same as described above with reference to FIG. 2.

### EXAMPLE 1

In this example, a 2-kW MCFC stack was constructed using twenty-one (21) unit cells. Cooling separators (Nos. 4, 9, 14, and 19) were mounted. The effective area of electrode in each cell was 1000 cm². Li-doped Ni was used as a cathode, a Ni—Al alloy was used as an anode, (Li/K)CO₃ (Li/K=62/38 mol %) was used for an electrolyte, and a matrix formed of fiber-reinforced LiAlO₂ was used. The cooling separators were made of stainless steel (refer to FIGS. 3 and 4). To prevent corrosion, wet seal was coated with aluminum. The direction of general cathode and anode gas flow in each of the separators was set to be a co-flow direction.

Until 50 minutes, a load of 100 A was applied to the stack so that a thermal equilibrium state was maintained. Herein, the oxygen utilization ratio was 0.4, and the hydrogen utilization ratio was 0.6. The temperature of an inlet of the separator in which cooling gas for cathode flows was set to 500° C. After 50 minutes, the valve 30 (refer to FIG. 5) was closed slowly, and the valve 20 (refer to FIG. 5) was opened. Further, the cooling effect of the stack was observed while maintaining the ratio of general cathode gas and cooling gas for cathode to be 60:40.

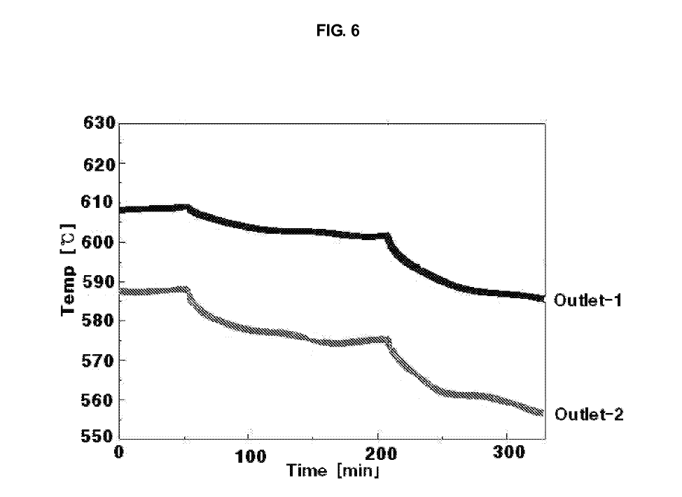

FIG. 6 is a graph showing temperature changes at two outlet positions (outlet-1 and outlet-2) of two outlets of the cooling separator No. 4 in accordance with time, in the first example of the invention.

The temperature changes at the outlet positions (the outlet-1 and the outlet-2) of the corresponding separator No. 4 were plotted respectively (FIG. 6). In FIG. 6, the upper graph indicates the temperature change at the outlet-1, and the lower graph indicates the temperature change at the outlet-2.

As shown in FIG. 6, the temperature decreased in both of the cases where the ratio of the cooling gas was 40% and 100%. This means that heat exchange is performed well at the corresponding positions of the cooling separator.

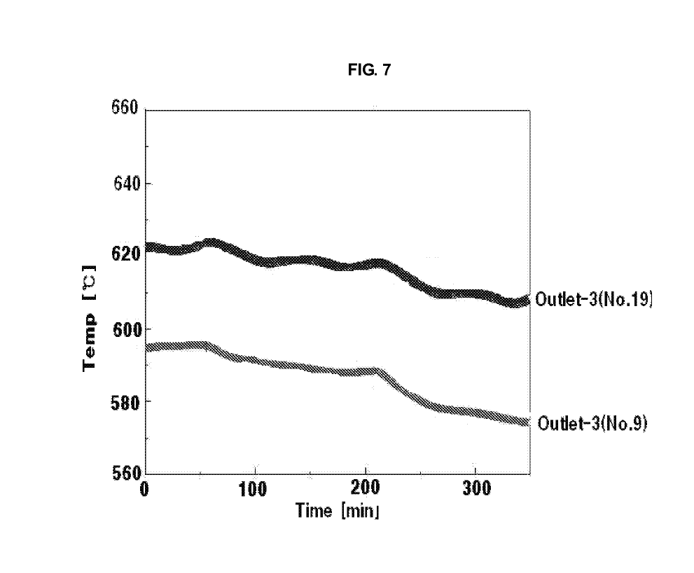

FIG. 7 is a graph showing temperature changes at the same outlet position (outlet-3) of the separators No. 9 and 19, which are separated from each other in a height direction, in accordance with time. In FIG. 7, the upper graph indicates the temperature change in the separator No. 19 and the lower graph indicates the temperature change in the separator No. 9.

As shown in FIG. 7, the temperature decreased when the cooling gas flew in the separators separated in direction of height. This means that the stack is cooled in direction of height, as well as at any one position of the stack.

### EXAMPLE 2

In this example, the cooling gas was substituted with anode gas, while the construction thereof was similar to that of the first example.

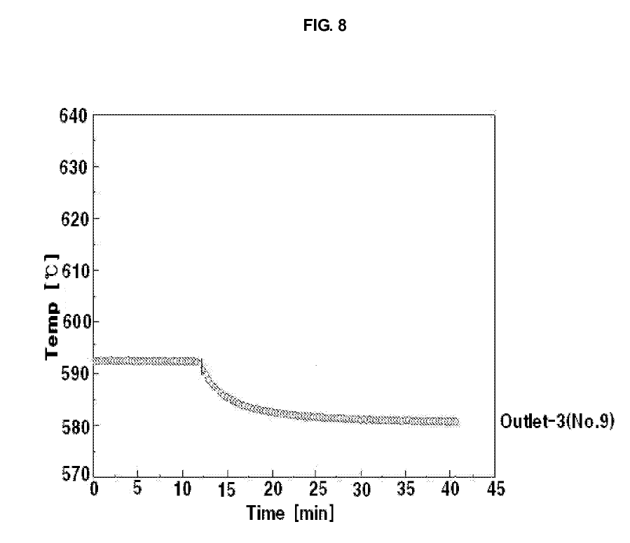

FIG. 8 is a graph showing temperature changes at the outlet position (outlet-3) of the separator No. 9 in accordance with time, in the second example of the invention. In this case, the hydrogen utilization ratio was set to 0.7, the oxygen utilization ratio was set to 0.4, and the inlet temperature of the cooling separator No. 9 was set to 500° C. After the thermal equilibrium state was maintained under a load of 75 A, cooling anode gas was supplied. As a result, the temperature decreased as show in FIG. 8.

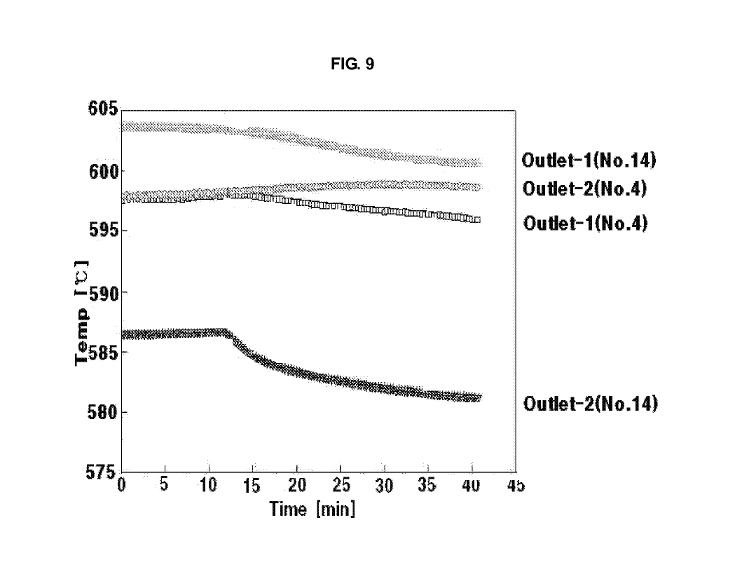

FIG. 9 is a graph showing temperature changes at the respective outlet positions (outlet-1 and outlet-2) of the separators Nos. 4 and 14, which were separated in direction of height, in accordance with time, in the second example of the invention.

As seen in FIG. 7, it can be also found in FIG. 9 that the stack was cooled in direction of height.

### COMPARATIVE EXAMPLE

As described above, it could be found that the temperature of the stack decreased until 380 minutes due to the cooling gas. After 380 minutes, the cooling gas flow was stopped (the valve 20 was closed), and only general gas was supplied. The other conditions were identical to those of the first example.

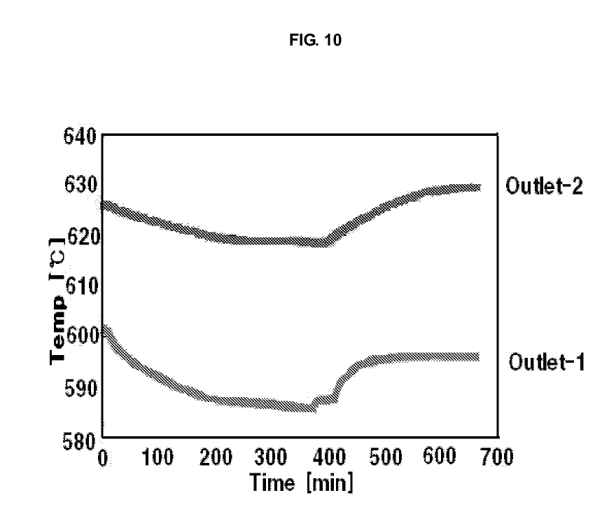

FIG. 10 is a graph showing temperature changes of the separator No. 14 in the comparative example of the invention. In FIG. 10, the upper graph indicates the temperature change at the outlet position outlet-2, and the lower graph indicates the temperature change at the outlet position outlet-1.

As shown in FIG. 10, the temperature increased sharply after 380 minutes, when only general gas was supplied.

According to the present invention, the cooling of the stack can be achieved effectively, and the corrosion of the MCFC can be prevented, which contributes to the enhancement of durability. Further, the operation can be performed at low pressure difference so that matrix wet seal resistance is increased, which also contributes to the enhancement of durability. As well, since the general gas is divided and supplied by the cooling gas flow, it is possible to improve the distribution of anode gas and cathode gas even in a structure of multilayered stack.

What is claimed is:

1. A separator for cooling an MCFC, comprising:
a cooling gas flow path provided in the separator, a cooling anode gas or a cooling cathode gas flowing through the cooling gas flow path, the cooling anode gas or the cooling cathode gas having a temperature lower than that of a general anode gas or a general cathode gas which is supplied to an anode or a cathode of the MCFC.

2. The separator according to claim 1, wherein the separator is an internal manifold type separator.

3. The separator according to claim 1, further comprising an inlet pipe connected to one side of the separator, the inlet pipe guiding the cooling gas into the inner parts of the separator.

4. The separator according to claim 1, further comprising a general cathode gas flow path and/or a general anode gas flow path.

5. The separator according to claim 1, comprising:
a general cathode gas flow path;
a general anode gas flow path; and
a cooling gas flow path,
wherein the cooling gas flow path is interposed between the general cathode gas flow path and the general anode gas flow path.

6. The separator according to claim 5, wherein the general cathode gas flow path comprises:
a mask plate which covers the outside of the general cathode gas flow path;
a gas channel inside the mask plate; and
a plurality of shielded slots which are formed in the mask plate so as to partition off the channel and to collect currents.

7. The separator according to claim 6, wherein the mask plate comprises a corrosion-preventing coating layer formed thereon.

8. The separator according to claim 5, wherein the general anode gas flow path comprises:
a mask plate which covers the outside of the general anode gas flow path;
a gas channel inside the mask plate; and
a plurality of shielded slots which are formed in the mask plate so as to partition off the channel and to collect currents.

9. The separator according to claim 8, wherein the mask plate comprises a corrosion-preventing coating layer formed thereon.

10. The separator according to claim 5, wherein the cooling gas flow path comprises:
a mask plate which covers the outside of the cooling gas flow path;
a cooling gas channel inside the mask plate; and
a plurality of shielded slots which are formed in the mask plate so as to partition off the channel.

11. The separator according to claim 10, wherein the mask plate comprises a corrosion-preventing coating layer formed thereon.

12. The separator according to claim 5, wherein the cooling gas flow path is connected to the general anode gas flow path or the general cathode gas flow path so that the cooling gas flowing out of the cooling gas flow path is introduced again into the general anode gas flow path or the general cathode gas flow path.

13. An MCFC comprising one or more of the separator for cooling an MCFC according to claim 1, which are provided in a stack of the MCFC.

14. The MCFC according to claim 13, wherein the MCFC comprises:
the MCFC stack;
one or more of the separator, which are provided in the MCFC stack;
a gas supply flow path of general anode gas or a general cathode gas through which a general anode gas or a general cathode gas is supplied to an anode or a cathode of the MCFC stack; and
a gas supply flow path of a cooling anode gas or a cooling cathode gas through which a cooling anode gas or a cooling cathode gas is supplied to the separator, the cooling anode gas or the cooling cathode gas having a temperature lower than that of the general anode gas or the general cathode gas.

15. The MCFC according to claim 14, wherein the gas supply flow path of the cooling anode gas or the cooling cathode gas diverges from the gas supply flow path of the general anode gas or the general cathode gas, and the general anode gas or the general cathode gas is cooled to be a cooling anode gas or a cooling cathode gas after the diverging.

16. The MCFC according to claim 13, wherein the surface of the cooling separator is formed of steel so that the cooling separator is insulated from electrolyte supplied to the stack.

17. The MCFC according to claim 14, wherein the general anode gas or the general cathode gas is heat-exchanged with the cooling anode gas or the cooling cathode gas in the separator.

18. The MCFC according to claim 14, wherein the general anode gas or the general cathode gas is heat-exchanged with the cooling anode gas or the cooling cathode gas in the separator while the general anode gas or the general cathode gas flows in an opposite direction to the flow of the cooling anode gas or the cooling cathode gas.

19. The MCFC according to claim 18, wherein the heat-exchanged cooling anode gas or the cooling cathode gas is mixed with the general anode gas or the general cathode gas, and then flows out of the separator so as to be distributed.

20. A method for cooling an MCFC, comprising the step of:
supplying a cooling anode gas or a cooling cathode gas to a stack of the MCFC having one or more of the separator according to claim 1, thereby cooling the MCFC.

21. The method according to claim 20, comprising the steps of:
supplying a general anode gas or a general cathode gas to the stack of the MCFC; and
supplying the cooling anode gas or the cooling cathode gas to the separator after stopping the supplying of the general anode gas or the general cathode gas.

22. The method according to claim 20, comprising the steps of:
supplying a general anode gas or a general cathode gas to the stack of the MCFC; and
supplying the cooling anode gas or the cooling cathode gas to the separator while continuously performing the supplying of the general anode gas or the general cathode gas.
